(19) United States
(12) Patent Application Publication
(10) Pub. No.: US 2013/0223900 A1
(43) Pub. Date: Aug. 29, 2013

(54) IMAGE FORMING APPARATUS

(71) Applicant: FUJI XEROX CO., LTD., (US)

(72) Inventors: Koichi WATANABE, Kanagawa (JP); Shuichi NISHIDE, Kanagawa (JP); Wataru SUZUKI, Kanagawa (JP); Tetsuji OKAMOTO, Kanagawa (JP); Atsushi OGIHARA, Kanagawa (JP); Masahiro SATO, Kanagawa (JP); Atsuyuki KITAMURA, Kanagawa (JP)

(73) Assignee: FUJI XEROX CO., LTD., Tokyo (JP)

(21) Appl. No.: 13/667,438

(22) Filed: Nov. 2, 2012

(30) Foreign Application Priority Data
Feb. 23, 2012 (JP) 2012-037709

(51) Int. Cl. G03G 15/01

(52) U.S. Cl. 399/304

(57) ABSTRACT

An image forming apparatus includes an image carrier, a transfer member, a leading end holding member, a trailing end holding member, a detection unit, and a stopping unit. The trailing end holding member is disposed so as to be rotatable around the transfer member such that a gap is formed between the trailing end holding member and the transfer member. The trailing end holding member holds a trailing end of the recording medium after a leading end of the recording medium held by the leading end holding member has passed through the gap. The detection unit detects whether the leading end of the recording medium passes through the gap after the leading end holding member performed a holding operation on the leading end. The stopping unit stops rotation of the transfer member when the detection unit detects that the leading end does not pass through the gap.

### CROSS-REFERENCE TO RELATED APPLICATIONS

This application is based on and claims priority under 35 USC 119 from Japanese Patent Application No. 2012-037709 filed Feb. 23, 2012.

### BACKGROUND

### Technical Field

The present invention relates to an image forming apparatus.

### SUMMARY

According to an aspect of the invention, an image forming apparatus includes an image carrier, a transfer member, a leading end holding member, a trailing end holding member, a detection unit, and a stopping unit. The image carrier carries an image on an outer peripheral surface thereof. The transfer member is disposed such that an outer peripheral surface thereof is in contact with the outer peripheral surface of the image carrier. The transfer member transports a recording medium and transfers the image carried by the image carrier to the recording medium. The leading end holding member is disposed on the transfer member and holds a leading end of the recording medium in a transport direction. The trailing end holding member is disposed at a predetermined standby position such that a gap is formed between the trailing end holding member and the outer peripheral surface of the transfer member. The trailing end holding member is rotatable around the transfer member independently of the transfer member. The trailing end holding member holds a trailing end of the recording medium in the transport direction after the leading end of the recording medium in the transport direction held by the leading end holding member has passed through the gap while the transfer member rotates. The detection unit detects whether the leading end of the recording medium passes through the gap after the leading end holding member performed a holding operation on the leading end. The stopping unit stops rotation of the transfer member when the detection unit detects that the leading end does not pass through the gap.

### BRIEF DESCRIPTION OF THE DRAWINGS

Exemplary embodiments of the present invention will be described in detail based on the following figures, wherein:

FIG. 1 is a schematic view illustrating the structure of an image forming apparatus;

FIGS. 2A and 2B are schematic views illustrating the structure of a transfer device;

FIGS. 3A to 3C illustrate an image forming operation;

FIGS. 4A to 4C illustrate the image forming operation;

FIGS. 5A and 5B illustrate the image forming operation;

FIG. 6 is a schematic view illustrating the structure of a transfer device according to another exemplary embodiment;

FIGS. 7A and 7B are schematic views illustrating a modification of the transfer device illustrated in FIG. 6;

FIGS. 8A and 8B are schematic views illustrating a modification of the transfer device illustrated in FIGS. 7A and 7B;

FIGS. 9A and 9B are schematic views illustrating a modification of the transfer device illustrated in FIGS. 2A and 2B; and

FIGS. 10A and 10B are schematic vies illustrating a modification of the transfer devices illustrates FIGS. 2A, 2B, 7A, and 7B.

### DETAILED DESCRIPTION

Hereinafter, an exemplary embodiment of the present invention will be described with reference to the drawings.

Structure of Image Forming Apparatus According to Present Exemplary Embodiment

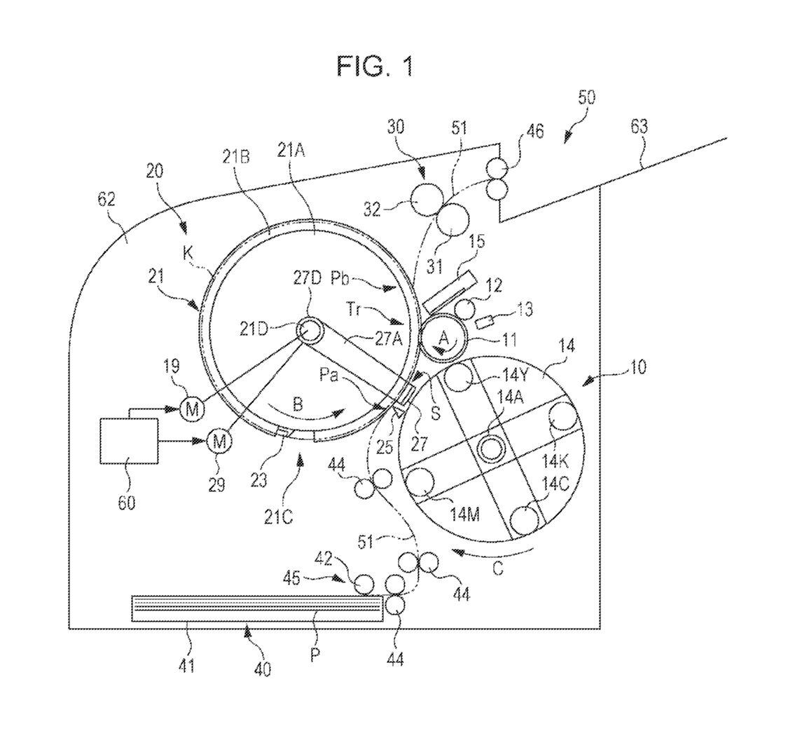

First, the structure of an image forming apparatus according to the present exemplary embodiment will be described. FIG. 1 is a schematic view illustrating the structure of an image forming apparatus 50 according to the present exemplary embodiment.

As illustrated in FIG. 1, the image forming apparatus 50 includes an image forming apparatus body 62 and various components disposed in the image forming apparatus body 62. An image forming unit 10, a recording medium feeder 40, and a controller 60 are disposed in the image forming apparatus body 62. The image forming unit 10 forms an image on a recording medium P, which is an example of a transported object. The recording medium feeder 40 feeds the recording medium P to the image forming unit 10. The controller 60 controls the operation of each component of the image forming apparatus 50. A recording medium output unit 63 is disposed on an upper part of the image forming apparatus body 62. After an image has been formed on the recording medium P by the image forming unit 10, the recording medium P is output to the recording medium output unit 63.

The recording medium feeder 40 includes a recording medium container 41 and a transport unit 45. The recording medium container 41 contains the recording medium P. The transport unit 45 transports the recording medium P from the recording medium container 41 to the image forming unit 10. The transport unit 45 includes a feed roller 42 and plural transport rollers 44. The feed roller 42 feeds the recording medium P contained in the recording medium container 41. The transport rollers 44 are arranged along a transport path 51 of the recording medium P and transport the recording medium P, which has been fed by the feed roller 42, to the image forming unit 10.

The image forming unit 10 includes a photoconductor drum 11 and a transfer device 20. The photoconductor drum 11 is an example of an image carrier that carries an image. The transfer device 20 transfers the image (toner image), which is carried by the photoconductor drum 11, to the recording medium P. The photoconductor drum 11 rotates in one direction (for example, the direction of arrow A in FIG. 1).

A charging roller 12, an exposure device 13, a rotary developing device 14, and a cleaner 15 are arranged around the photoconductor drum 11 in the rotation direction of the photoconductor drum 11. The charging roller 12, which is an example of a charger, charges the photoconductor drum 11. The exposure device 13 exposes the photoconductor drum 11, which has been charged by the charging roller 12, with light, and thereby forms an electrostatic latent image on the photoconductor drum 11. The rotary developing device 14, which is an example of a developing device, develops the electrostatic latent image, which has been formed on the photoconductor drum 11 by the exposure device 13, and thereby forms a toner image. The cleaner 15 cleans residual toner (developer) remaining on the photoconductor drum 11.

The exposure device 13 forms an electrostatic latent image on the basis of an image signal sent from the controller 60. Examples of an image signal sent from the controller 60 include an image signal received by the controller 60 from an external apparatus.

The rotary developing device 14 includes a rotation shaft 14A; and developing units 14Y, 14M, 14C, and 14K for yellow (Y), magenta (M), cyan (C), and black (K), which are arranged around the rotation shaft 14A in the circumferential direction of the rotation shaft 14A. The rotary developing device 14 rotates around the rotation shaft 14A in the direction of arrow C. When one of the developing units 14Y, 14M, 14C, and 14K of the rotary developing device 14 is located at a facing position at which the developing unit faces the photoconductor drum 11, an electrostatic latent image formed on the photoconductor drum 11 is developed by using a color toner corresponding to the developing unit located at the facing position, and thereby a toner image is formed.

The transfer device 20 includes a transfer drum 21 that is disposed such that the outer peripheral surface of the transfer drum 21 is in contact with the outer peripheral surface of the photoconductor drum 11. The transfer drum 21 transfers an image that is carried by the photoconductor drum 11 to the recording medium P. The transfer drum 21 is an example of a transfer member. In the transfer device 20, the recording medium P, which has been transported by the transport unit 45, is wound around the outer peripheral surface of the transfer drum 21 (to be specific, the outer peripheral surface of an elastic layer 21B described below), and rotates together with the photoconductor drum 11. As a result, the recording medium P is transported to a transfer position Tr (transfer region) between the transfer drum 21 and the photoconductor drum 11, and the transfer drum 21 transfers a toner image from the photoconductor drum 11 to the recording medium P. As described below, a leading end gripper 23 and a trailing end gripper 27 respectively grip the leading end and the trailing end of the recording medium P in the transport direction, and thereby the recording medium P is wound around the outer peripheral surface of the transfer drum 21.

The recording medium P is supplied to the transfer drum 21 at a supply position Pa shown in FIG. 1 (a holding-start position at which the leading end gripper 23 (described below) starts holding the recording medium P). The recording medium P is peeled off the transfer drum 21 at a peel-off position Pb shown in FIG. 1 (a holding-finish position at which the leading end gripper 23 finishes holding the recording medium P). The structure of the transfer device 20 will be described below in detail.

A fixing unit 30 is disposed downstream of (in FIG. 1, above) the transfer position Tr along the transport path 51. The fixing unit 30 fixes the toner image, which has been transferred to the recording medium P by the transfer device 20, to the recording medium P. The fixing unit 30 includes a heating roller 31 and a pressing roller 32. The heating roller 31 heats the toner image on the recording medium P. The pressing roller 32 presses the recording medium P as a result of being pressed against the heating roller 31.

In the fixing unit 30, the recording medium P is pressed and heated by the pressing roller 32 and the heating roller 31, which rotate with the recording medium P therebetween while transporting the recording medium P downstream (in FIG. 1, upward) along the transport path 51. As a result, the toner image is fixed to the recording medium P.

Output rollers 46 are disposed downstream of the fixing unit 30 along the transport path 51.

The output rollers 46 output the recording medium P, to which the toner image has been fixed, to the recording medium output unit 63.

### Structure of Transfer Device 20

Next, the structure of the transfer device 20 will be described.

As illustrated in FIG. 1, the transfer device 20 includes the transfer drum 21, the leading end gripper 23, and the trailing end gripper 27. The leading end gripper 23, which is an example of a leading end holding member, is disposed on the transfer drum 21 and grips the leading end of the recording medium P in the transport direction. The trailing end gripper 27, which is an example of a trailing end holding member, is disposed on the transfer drum 21 and grips the trailing end of the recording medium P in the transport direction.

A detection sensor 25 for detecting passage of the recording medium P is disposed so as to face the outer peripheral surface of the transfer drum 21. The detection sensor 25 is disposed upstream of a standby position (described below) of the trailing end gripper 27 (the position of the trailing end gripper 27 shown in FIG. 1) in the transport direction of the recording medium P and on the transport path along which the recording medium P, which has been fed from the recording medium container 41, passes.

### Transfer Drum 21

As illustrated in FIG. 1, the transfer drum 21 is disposed in the image forming apparatus body 62 so as to face the photoconductor drum 11 and so as to be rotatable around a rotation shaft 21D. The rotation shaft 21D is rotated by a drive motor 19 that is controlled by the controller 60, and thereby the transfer drum 21 rotates.

The transfer drum 21 includes a base member 21A having a cylindrical shape and the elastic layer 21B formed on the outer peripheral surface of the base member 21A. The base member 21A is electroconductive and is made of, for example, a metal material. The elastic layer 21B is made of a semi-conductive elastic material (for example, a resin material such as a polyurethane resin).

The transfer drum 21 rotates in the direction of arrow B in synchronism with the rotation of the photoconductor drum 11 while the elastic layer 21B is in contact with the photoconductor drum 11. A part of the elastic layer 21B that contacts the photoconductor drum 11 becomes elastically deformed.

A voltage (transfer bias) having a polarity opposite to that of toner is applied to the base member 21A of the transfer drum 21, and thereby a toner image is transferred from the photoconductor drum 11 to the recording medium P, which is wound around the elastic layer 21B, at the transfer position Tr.

A portion of the outer peripheral surface of the base member 21A in the circumferential direction is not covered with the elastic layer 21B. This portion, on which the elastic layer 21B is not disposed, will be referred to as a cutout portion 21C. That is, the cutout portion 21C, which is an example of a recess, is formed in the outer peripheral surface of the transfer drum 21. Even when the outer peripheral surface of the base member 21A in the cutout portion 21C faces the photoconductor drum 11, the outer peripheral surface does not contact the photoconductor drum 11. A non-conductive layer or the like may be formed on the outer peripheral surface of the base member 21A in the cutout portion 21C.

In FIG. 1, the outer periphery of the transfer drum 21 when the elastic layer 21B is elastically deformed is shown by two-dot chain line K. For clarity, the two-dot chain line K is drawn around the entire circumference of the transfer drum 21.

### Leading End Gripper 23

As illustrated in FIG. 1, the leading end gripper 23 is disposed in the cutout portion 21C of the transfer drum 21. The leading end gripper 23 rotates together with the transfer drum 21.

The leading end gripper 23 is rotatably supported by the transfer drum 21 (to be specific, the base member 21A) at a base end (a downstream end in the rotation direction of the transfer drum 21) of the leading end gripper 23. A tip end (an upstream end in the rotation direction of the transfer drum 21) of the leading end gripper 23 is capable of contacting and becoming separated from the outer peripheral surface of the transfer drum 21.

When the leading end gripper 23 rotates around the base end in a direction so that the tip end is separated from the outer peripheral surface of the transfer drum 21, the recording medium P may enter a space between the tip end and the outer peripheral surface of the transfer drum 21. When the leading end gripper 23 rotates around the base end in the opposite direction, the leading end gripper 23 holds the recording medium P between the tip end and the outer peripheral surface of the transfer drum 21.

The leading end gripper 23 has a plate-like shape extending in the axial direction of the transfer drum 21. The length of the leading end gripper 23 in the axial direction is larger than the maximum width of the recording medium P, which is wound around the transfer drum 21, in the axial direction of the transfer drum 21.

When the leading end gripper 23 is holding the recording medium P, the leading end gripper 23 is capable of passing the transfer position Tr without contacting the photoconductor drum 11. That is, when the leading end gripper 23 is holding the recording medium P, the leading end gripper 23 is located inside of the two-dot chain line K in FIG. 1.

Trailing End Gripper 27

As illustrated in FIG. 1, the trailing end gripper 27 straddles the outer peripheral surface of the transfer drum 21 in the axial direction of the transfer drum 21. The trailing end gripper 27 is supported by support portions 27A disposed at ends of the transfer drum 21 in the axial direction so that the trailing end gripper 27 is capable of contacting and becoming separated from the outer peripheral surface of the transfer drum 21. When the trailing end gripper 27 is separated from the outer peripheral surface of the transfer drum 21, there is a space S between the trailing end gripper 27 and the outer peripheral surface of the transfer drum 21.

The support portions 27A are rotatably supported by a rotation shaft 27D that is coaxial with the rotation shaft 21D of the transfer drum 21. The rotation shaft 27D is rotated by a drive motor 29 controlled by the controller 60. As a result, the trailing end gripper 27 rotates around (the outer periphery of) the transfer drum 21 independently of the transfer drum 21.

Before the trailing end gripper 27 grips the recording medium P, the trailing end gripper 27 is located at a predetermined standby position (the position of the trailing end gripper 27 illustrated in FIG. 1) on the rotation path of the trailing end gripper 27. The standby position is, for example, a position on the transport path 51 between the transfer position Tr (transfer region) and the supply position Pa in the rotation direction of the transfer drum 21.

The trailing end gripper 27 is made of a resin material (such as PET, a polyimide resin, or a fluorocarbon resin) and has a plate-like shape (film-like shape) extending in the axial direction of the transfer drum 21. The length of the trailing end gripper 27 in the axial direction is larger than the maximum width of the recording medium P (in the axial direction of the transfer drum 21), which is wound around the transfer drum 21. Alternatively, the trailing end gripper 27 may have a wire-like shape, a solid cylindrical shape, or the like.

When the detection sensor 25 detects passage of the trailing end of the recording medium P in the transport direction, the trailing end gripper 27 moves from a position in which the trailing end gripper 27 is separated from the transfer drum 21 to a position in which the trailing end gripper 27 contacts the transfer drum 21, and thereby holds the trailing end of the recording medium P by gripping the trailing end between the trailing end gripper 27 and the outer peripheral surface of the transfer drum 21 (to be specific, the outer peripheral surface of the elastic layer 21B).

As heretofore described, the leading end gripper 23 and the trailing end gripper 27 respectively grip the leading end and the trailing end of the recording medium P in the transport direction, and thereby the recording medium P is wound around the outer peripheral surface of the transfer drum 21.

Structure for Detecting that Leading End of Recording Medium in Transport Direction has Risen

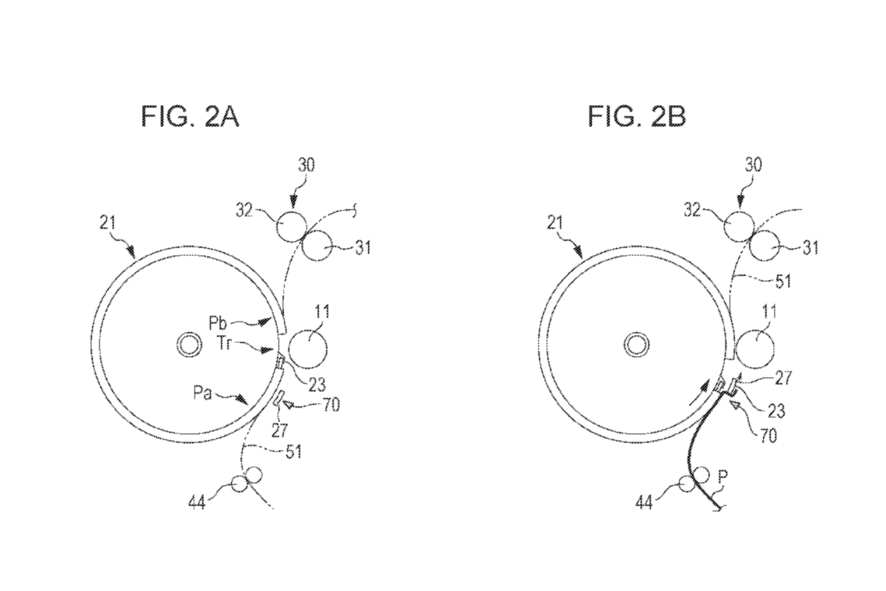

As illustrated in FIG. 2A, the transfer device 20 includes a detection sensor 70, which is an example of a detection unit. The detection sensor 70 detects that the leading end of the recording medium P in the transport direction has risen from the outer peripheral surface of the transfer drum 21 over the space S when the leading end was about to pass through the space S after the leading end gripper 23 performed a holding operation on the leading end.

To be specific, the detection sensor 70 detects whether the trailing end gripper 27, which is to be located at the standby position, has moved from the standby position. The trailing end gripper 27 is movable by a pressing force applied to the trailing end gripper 27 by the recording medium P whose leading end in the transport direction has risen from the outer peripheral surface of the transfer drum 21 over the space S.

To be specific, the trailing end gripper 27 is movable by using, for example, the following mechanism: a one-way clutch or a ratchet is disposed in the rotation shaft 27D of the trailing end gripper 27; a driving force of the drive motor 29 is transmitted to the rotation shaft 27D of the trailing end gripper 27 through the one-way clutch or the ratchet; and the rotation shaft 27D of the trailing end gripper 27 is rotated when the trailing end gripper 27 receives an external force. A stepping motor may be used as the drive motor 29. In this case, the trailing end gripper 27 may be moved by an external force generated when the stepping motor loses synchronism.

Thus, in the present exemplary embodiment, the trailing end gripper 27 is movable by a pressing force applied to the trailing end gripper by the recording medium P whose leading end in the transport direction has risen from the outer peripheral surface of the transfer drum 21. When the detection sensor 70 detects that the trailing end gripper 27 has moved from the standby position, it is determined that the leading end of the recording medium P in the transport direction on which the leading end gripper 23 performed a holding operation has risen from the outer peripheral surface of the transfer drum 21.

The detection sensor 70 is, for example, an optical sensor that emits light from the outer periphery of the trailing end gripper 27 (from a side farther from the transfer drum 21) toward the trailing end gripper 27 (or the support portions 27A). In this case, the detection sensor 70 detects movement of the trailing end gripper 27 by receiving reflected light reflected from the trailing end gripper 27 (or one of the support portions 27A) or the recording medium P (or the outer peripheral surface of the transfer drum 21) and by measuring a change in the intensity of the reflected light.

Alternatively, the detection sensor 70 may be an optical sensor (for example, a transmissive or reflective optical sensor) that detects movement of the trailing end gripper 27 by emitting light in the axial direction of the transfer drum 21. As a further alternative, the detection sensor 70 may be a switch that connects or interrupts an electric circuit when the trailing end gripper 27 moves.

When the detection sensor 70 detects movement of the trailing end gripper 27, a detection signal is sent to the controller 60. Then, the controller 60 controls driving of the drive motor 19 so as to stop rotation of the transfer drum 21. That is, the controller 60 functions as an example of a stopping unit that stops rotation of the transfer drum 21.

### Operation According to Present Exemplary Embodiment

Next, an operation according to the present exemplary embodiment, with which the image forming apparatus 50 forms a toner image on a recording medium P, will be described.

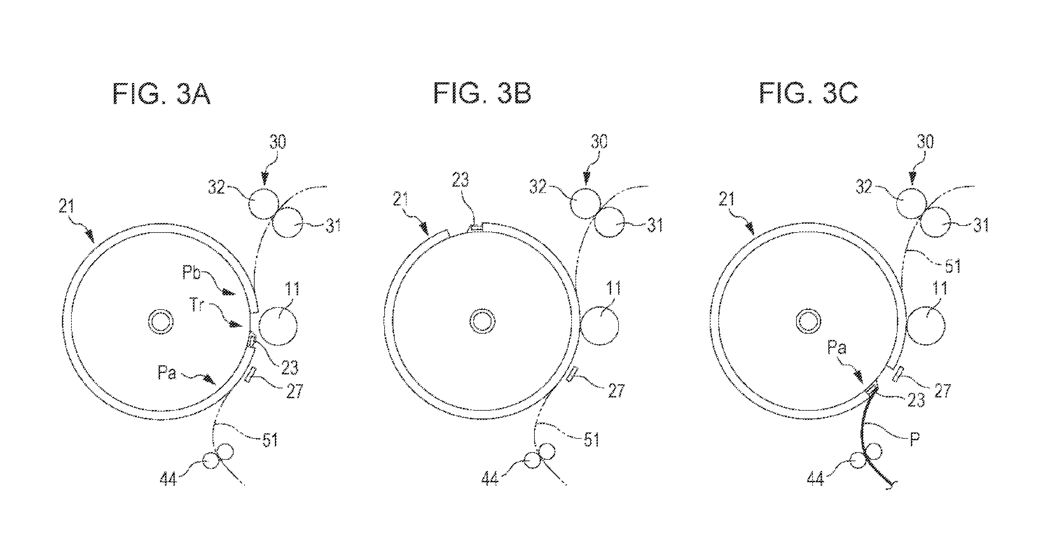

As illustrated in FIG. 3A, before an image forming operation is started, the leading end gripper 23 is located at a standby position between the transfer position Tr and the supply position Pa in the rotation direction of the transfer drum 21. The trailing end gripper 27 is located at the standby position, which is located between the transfer position Tr and the supply position Pa. The standby position of the trailing end gripper 27 is upstream of the standby position of the leading end gripper 23 in the rotation direction of the transfer drum 21.

When the image forming operation is started, the feed roller 42 feeds the recording medium P from the recording medium container 41, and the transport rollers 44 transport the recording medium P toward the transfer drum 21. As illustrated in FIG. 3B, while the recording medium P is transported toward the transfer drum 21, the transfer drum 21 rotates and the leading end gripper 23 moves from the standby position toward the supply position Pa. The transfer drum 21 is rotated by the drive motor 19 controlled by the controller 60 (see FIG. 1).

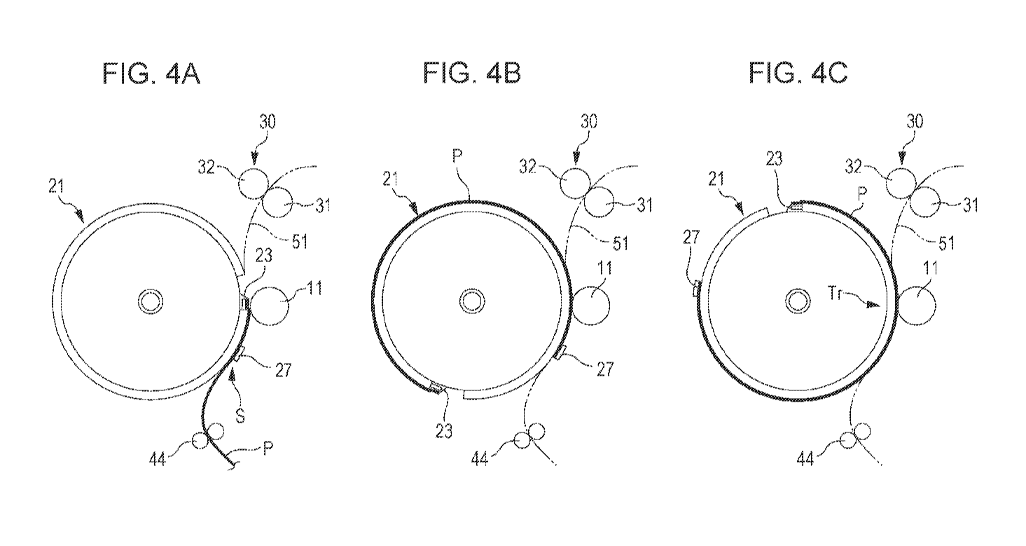

As illustrated in FIG. 3C, when the recording medium P has been transported to the transfer drum 21 by the transport rollers 44, the leading end gripper 23 grips the leading end of the recording medium P in the transport direction at the supply position Pa. As illustrated in FIG. 4A, while the transfer drum 21 rotates, the leading end of the recording medium P in the transport direction, which is gripped by the leading end gripper 23, passes through the space S between the transfer drum 21 and the trailing end gripper 27 located at the standby position. AS illustrated in FIG. 4B, when the detection sensor 25 (see FIG. 1) detects passage of the trailing end of the recording medium P in the transport direction after the leading end of the recording medium P in the transport direction has passed through the space S, the trailing end gripper 27 grips the trailing end of the recording medium P in the transport direction. Thus, the leading end gripper 23 and the trailing end gripper 27 respectively grip the leading end and the trailing end of the recording medium P in the transport direction, and thereby the recording medium P is wound around the outer peripheral surface of the transfer drum 21.

As illustrated in FIG. 4C, the transfer drum 21 and the trailing end gripper 27 rotate in synchronism with each other while the recording medium P is wound around the outer peripheral surface of the transfer drum 21, and thereby the recording medium P is rotated. Thus, the recording medium P is transported to the transfer position Tr. The trailing end gripper 27 is rotated by the drive motor 29 controlled by the controller 60 (see FIG. 1).

In the image forming unit 10 (see FIG. 1), the photoconductor drum 11 is charged by the charging roller 12 (charging) and exposed to light by the exposure device 13 (exposure), and thereby an electrostatic latent image is formed on the photoconductor drum 11. The electrostatic latent image is developed by the developing unit 14Y that faces the photoconductor drum 11, and thereby a yellow toner image is formed on the photoconductor drum 11 (development). The yellow toner image is transferred by the transfer drum 21 to the recording medium P, which has been transported to the transfer position Tr.

The transfer drum 21 and the trailing end gripper 27 rotate in synchronism with each other, and thereby rotate the recording medium P. The rotary developing device 14 rotates to a position at which the developing unit 14M faces the photoconductor drum 11. Charging, exposure, and development are performed as described above to form a magenta toner image on the photoconductor drum 11. The magenta toner image is transferred to the recording medium P, which is transported to the transfer position Tr again while the transfer drum 21 and the trailing end gripper 27 rotate. Likewise, cyan (C) and black (K) toner images are successively transferred to the recording medium P in an overlapping manner.

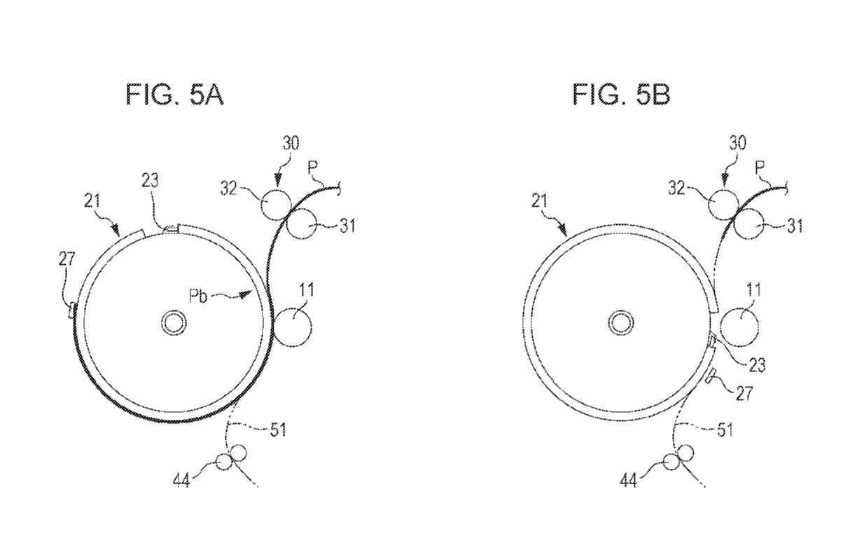

As illustrated in FIG. 5A, after the toner images have been transferred to the recording medium P in an overlapping manner, the leading end gripper 23 releases the leading end of the recording medium P in the transport direction at the peel-off position Pb, and thereby the recording medium P is peeled off the transfer drum 21.

As illustrated in FIG. 5B, the trailing end gripper 27 rotates to the standby position and releases the trailing end of the recording medium P in the transport direction and then waits at the standby position. The leading end gripper 23 rotates to the standby position together with the transfer drum 21 and waits at the standby position.

The recording medium P, which has been peeled off the transfer drum 21, is transported to the fixing unit 30, and the toner images are fixed to the recording medium P by the fixing unit 30. The recording medium P, on which the toner images have been fixed, is output to the recording medium output unit 63 by the output rollers 46. An image forming process is performed as heretofore described.

FIG. 2B illustrates a case where the leading end of the recording medium P in the transport direction has risen from the outer peripheral surface of the transfer drum 21 over the space S when the leading end was about to pass through the space S after the leading end gripper 23 performed a holding operation (see FIG. 3C) on the leading end. In this case, with the present exemplary embodiment, the leading end in the transport direction, which has risen, contacts the trailing end gripper 27 and presses the trailing end gripper 27 downstream in the rotation direction (toward the transfer position Tr). Thus, the trailing end gripper 27 moves downstream in the rotation direction.

The leading end of the recording medium P in the transport direction may rise from the outer peripheral surface of the transfer drum 21 over the space S if, for example, the leading end gripper 23 insufficiently grips the recording medium P and thereby a part of the recording medium P in the width direction (the axial direction of the transfer drum 21) that is located upstream of the standby position of the trailing end gripper 27 rises from the outer peripheral surface.

If the trailing end gripper 27 moves downstream in the rotation direction, the detection sensor 70 detects that the trailing end gripper 27 has moved from the standby position. The detection sensor 70 sends a detection signal indicating the movement of the trailing end gripper 27 to the controller 60. When the controller 60 receives the detection signal, the controller 60 controls the drive motor 19 so as to stop rotation of the transfer drum 21, and the rotation of the transfer drum 21 is stopped. Thus, the trailing end gripper 27 is prevented from being damaged because rotation of the transfer drum 21 is stopped if the trailing end gripper 27 is pressed by the recording medium P and a load is applied to the trailing end gripper 27. When the rotation of the transfer drum 21 is stopped, driving (rotation) of the photoconductor drum 11 and driving (rotation) of the transport unit 45 (the feed roller 42 and the transport rollers 44) are stopped.

With the present exemplary embodiment, the trailing end gripper 27 moves if the trailing end gripper 27 is pressed by the recording medium P whose leading end in the transport direction has risen from the outer peripheral surface of the transfer drum 21. Therefore, a force applied to the trailing end gripper 27 by the recording medium P is reduced, and thereby the trailing end gripper 27 is prevented from being damaged.

With the present exemplary embodiment, rotation of the transfer drum 21 is stopped when a load is actually applied to the trailing end gripper 27. Therefore, it is less likely that rotation of the transfer drum 21 is unnecessarily stopped than in a case where a detector directly detects the recording medium P whose leading end in the transport direction has risen from the outer peripheral surface of the transfer drum 21. In contrast, in a case where a sensor directly detects the recording medium P whose leading end in the transport direction has risen from the outer peripheral surface of the transfer drum 21, if the accuracy of detection is low, rotation of the transfer drum 21 may be stopped even if a load is not actually applied to the trailing end gripper 27.

### Another Embodiment of Transfer Device 20

The image forming apparatus 50 may include a transfer device 120 instead of the transfer device 20. Hereinafter, the transfer device 120 will be described. Only the difference between the transfer device 120 and the transfer device 20 will be described, and components of the transfer device 120 having the same functions as those of the transfer device 20 will be denoted by the same numerals and the description of such components will be omitted.

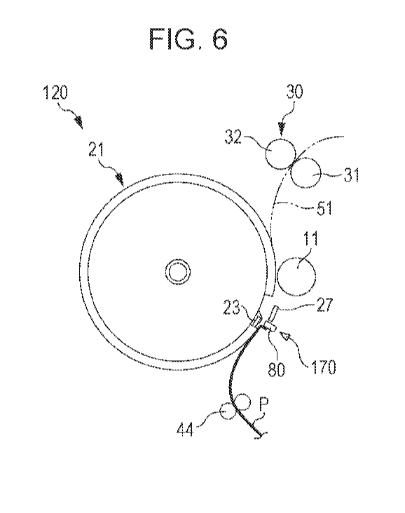

As illustrated in FIG. 6, the transfer device 120 includes a contact member 80 that is disposed upstream of the standby position of the trailing end gripper 27 in the transport direction of the recording medium P. The contact member 80 contacts the recording medium P whose leading end in the transport direction has risen from the outer peripheral surface of the transfer drum 21 over the space S. The contact member 80 is disposed in the image forming apparatus body 62 so as to be movable by a pressing force applied to the contact member 80 by the recording medium P whose leading end in the transport direction has risen from the outer peripheral surface of the transfer drum 21 over the space S.

To be specific, the contact member 80 is disposed in the image forming apparatus body 62 so as to be independent of the transfer drum 21 and the trailing end gripper 27. That is, the contact member 80 is not connected to the transfer drum 21 and the trailing end gripper 27 but is directly or indirectly attached to the image forming apparatus body 62.

The contact member 80 also serves as a protection member that covers, without contacting, an upstream part (a lower end part in FIG. 6) of the trailing end gripper 27 in the transport direction of the recording medium P. The contact member 80, serving as a protection member, protects the trailing end gripper 27 against the recording medium P whose leading end in the transport direction has risen from the outer peripheral surface of the transfer drum 21 over the space S.

The transfer device 120 includes a detection sensor 170 instead of the detection sensor 70. The detection sensor 170, which is an example of a detection unit, detects movement of the contact member 80. That is, with the transfer device 120, the detection sensor 170 detects that the leading end of the recording medium P in the transport direction on which the leading end gripper 23 performed a holding operation has risen from the outer peripheral surface of the transfer drum 21 over the space S by detecting that the contact member 80 has independently moved from the standby position.

As with the detection sensor 70, the detection sensor 170 is, for example, an optical sensor that emits light from an outer periphery of the contact member 80 (from a side farther from the transfer drum 21) toward the contact member 80. In this case, the detection sensor 170 detects movement of the contact member 80 by receiving reflected light reflected from the contact member 80 or the outer peripheral surface of the transfer drum 21 and by measuring a change in the intensity of the reflected light.

Alternatively, the detection sensor 170 may be an optical sensor (for example, a transmissive or reflective optical sensor) that detects movement of the contact member 80 by emitting light in the axial direction of the transfer drum 21. As a further alternative, the detection sensor 170 may be a switch that connects and breaks an electric circuit when the contact member 80 moves.

When the detection sensor 170 detects movement of the contact member 80, a detection signal is sent to the controller 60. Then, the controller 60 controls driving of the drive motor 19 so as to stop rotation of the transfer drum 21.

FIG. 6 illustrates a case where the leading end of the recording medium P in the transport direction has risen from the outer peripheral surface of the transfer drum 21 over the space S when the leading end was about to pass through the space S after the leading end gripper performed a holding operation (see FIG. 3C) on the leading end. In this case, with the transfer device 120, the leading end in the transport direction, which has risen, contacts the contact member 80 and presses the contact member 80 downstream in the rotation direction (toward the transfer position Tr). Thus, the contact member 80 moves downstream in the rotation direction.

If the contact member 80 moves downstream in the rotation direction, the detection sensor 170 detects the movement of the contact member 80. The detection sensor 170 sends a detection signal indicating the movement of the contact member 80 to the controller 60. Then, the controller 60 controls the drive motor 19 so as to stop rotation of the transfer drum 21, and the rotation of the transfer drum 21 is stopped.

Thus, the transfer device 120 detects that the leading end of the recording medium P in the transport direction has risen from the outer peripheral surface of the transfer drum 21 before the recording medium P contacts the trailing end gripper 27. That is, before a load is applied to the trailing end gripper 27 by the recording medium P, the transfer device 120 detects that the leading end of the recording medium P in the transport direction has risen. As a result, the trailing end gripper 27 is more effectively prevented from being damaged.

Moreover, because the contact member 80 of the transfer device 120 also functions as a protection member, the trailing end gripper 27 is more effectively prevented from being damaged.

The contact member 80 may be in contact with the trailing end gripper 27, and the contact member 80 may be moved together with the trailing end gripper 27 when the contact member 80 is pressed by the recording medium P whose leading end has risen from the outer peripheral surface of the transfer drum 21.

### Modifications of Transfer Device 120

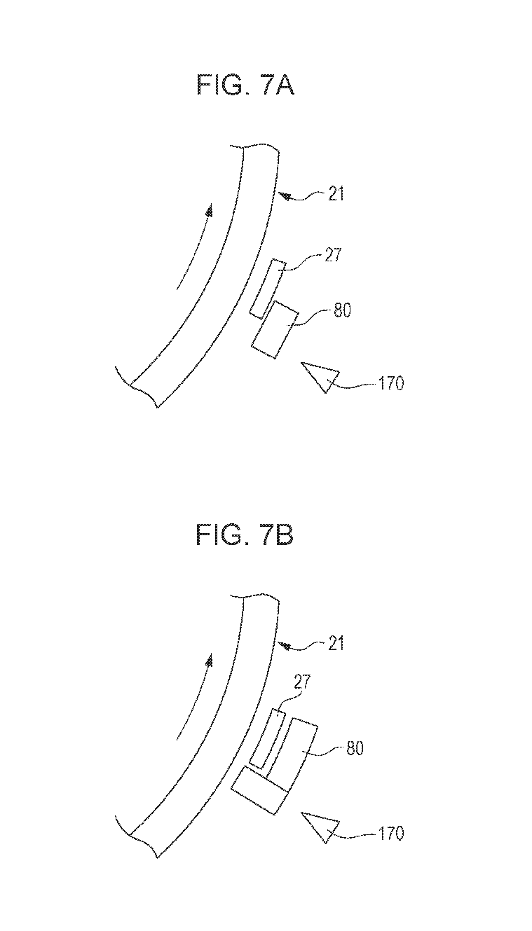

As illustrated in FIG. 7A, at least a part of the contact member 80 may be disposed over the outer periphery of the trailing end gripper 27 so as to be located upstream of the standby position of the trailing end gripper 27 in the transport direction of the recording medium P.

Alternatively, as illustrated in FIG. 7B, the contact member 80 may cover the outer periphery of the trailing end gripper 27 in addition to the upstream part of the trailing end gripper 27 in the transport direction of the recording medium P (the lower end part in FIG. 7B).

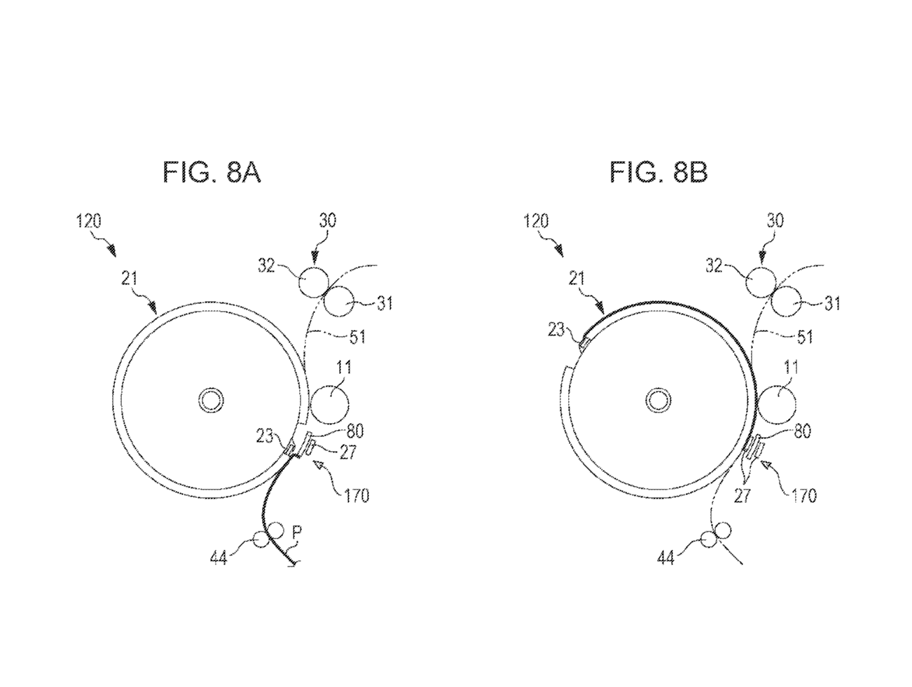

As a further alternative, as illustrated in FIG. 8A, at least a part the contact member 80 may be disposed over the inner periphery of the trailing end gripper 27 so as to be located upstream of the standby position of the trailing end gripper 27 in the transport direction of the recording medium P.

In the case where the contact member 80 is disposed over the inner periphery of the trailing end gripper 27, as illustrated in FIG. 8B, for example, a cutout portion (not shown) is formed in at least one of the contact member 80 and the trailing end gripper 27 so as to allow the trailing end gripper 27 to pass through the contact member 80 when the trailing end gripper 27 moves so as to contact and become separated from the outer peripheral surface of the transfer drum 21.

### Modifications of Transfer Devices 20 and 120

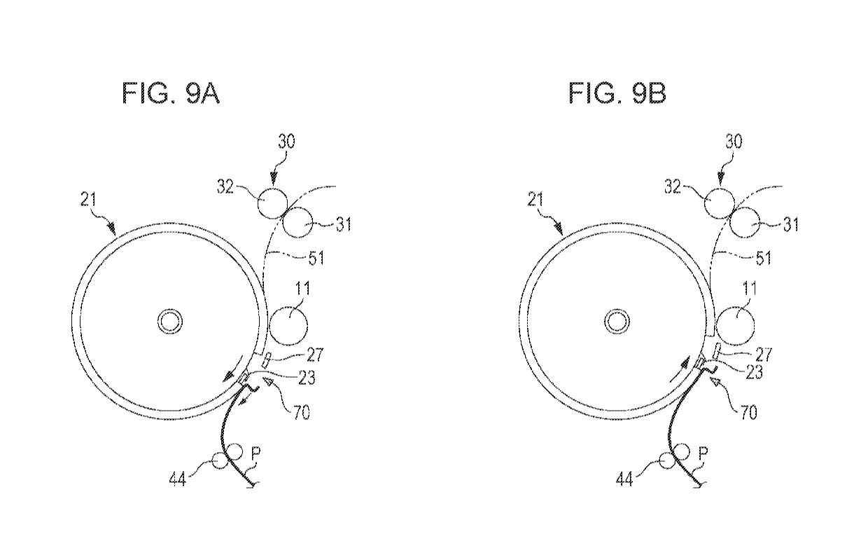

With the transfer device 20, when the controller 60 receives a detection signal from the detection sensor 70, the controller 60 simply controls the drive motor 19 so as to stop rotation of the transfer drum 21. However, as illustrated in FIG. 9A, the controller 60 may control the drive motor 19 so that rotation of the transfer drum 21 is stopped after transporting the recording medium P in a direction opposite to the transport direction by reversely rotating the transfer drum 21. With this modification, rotation of the transfer drum 21 is stopped after the trailing end gripper 27 has been relieved of a load applied by the recording medium P whose leading end in the transport direction has risen from the outer peripheral surface of the transfer drum 21. The modification illustrated in FIG. 9A is applicable not only to the transfer device 20 but also to the transfer device 120.

In addition to or instead of the modification illustrated in FIG. 9A, as illustrated in FIG. 9B, the controller 60 may control the drive motor 19 so that rotation of the transfer drum 21 is stopped after the trailing end gripper 27 rotates downstream in the transport direction of the recording medium P. With this modification, rotation of the transfer drum 21 is stopped after the trailing end gripper 27 has been relieved of a load applied by the recording medium P whose leading end in the transport direction has risen from the outer peripheral surface of the transfer drum 21. The modification illustrated in FIG. 9B is applicable not only to the transfer device 20 but also to the transfer device 120.

Ease of motion (movement resistance) of the trailing end gripper 27 of the transfer device 20 and the contact member 80 of the transfer device 120 may be variable. For example, when forming an image on a thin recording medium P or when humidity is low, the movement resistance of the trailing end gripper 27 (or the contact member 80) may be reduced to increase ease of motion. When forming an image on a thick recording medium P or on an envelope, the movement resistance of the trailing end gripper 27 (or the contact member 80) may be increased to reduce ease of motion. When transporting a thick recording medium P or an envelope, the trailing end gripper 27 may receive a load even when such a thick sheet normally passes through the space S. By changing ease of motion (movement resistance) as described above, rotation of the transfer drum 21 is prevented from being unintentionally stopped. The movement resistance of the trailing end gripper 27 may be changed by, for example, changing an excitation current applied to a stepping motor that is used as the drive motor 29.

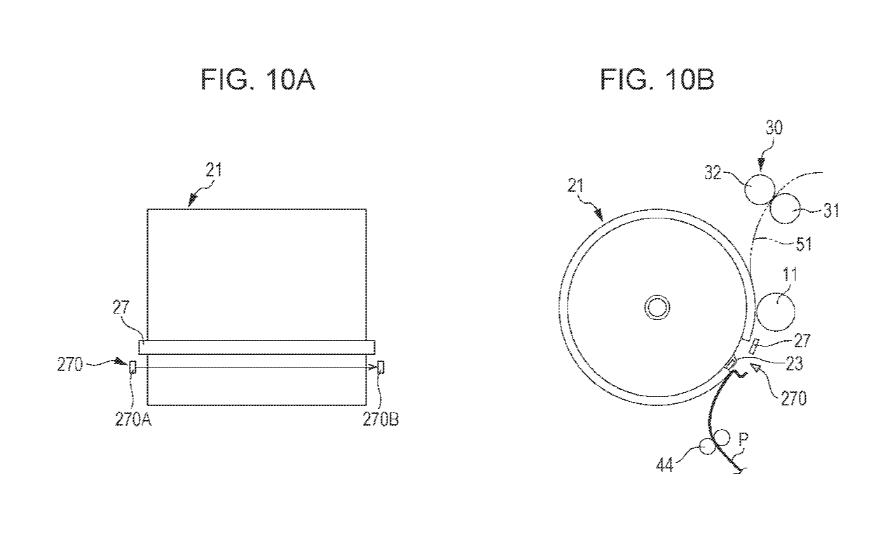

The transfer device 20 and the transfer device 120 respectively detect movement of the trailing end gripper 27 and movement of the contact member 80, and thereby detects that the leading end of the recording medium P in the transport direction on which the leading end gripper 23 performed a holding operation has risen from the outer peripheral surface of the transfer drum 21 over the space S. Instead, as illustrated in FIGS. 10A and 10B, a detection sensor 270 may be used to directly detect the leading end of the recording medium P in the transport direction that has risen from the outer peripheral surface of the transfer drum 21 over the space S. As illustrated in FIG. 10A, the detection sensor 270 is, for example, a transmissive optical sensor that includes a light emitter 270A and a light receiver 270B and detects the leading end of the recording medium P in the transport direction. The light emitter 270A is disposed at one end of the transfer drum 21 in the axial direction and emits light in the axial direction of the transfer drum 21. The light receiver 270B is disposed at the other end of the transfer drum 21 in the axial direction. As illustrated in FIG. 10B, the detection sensor 270 is disposed upstream of the standby position of the trailing end gripper 27 in the transport direction of the recording medium P and detects that the leading end of the recording medium P in the transport direction has risen from the outer peripheral surface of the transfer drum 21 over the space S at a position upstream of the standby position in the transport direction of the recording medium P. The detection sensor 270 may be a reflective optical sensor.

The present invention is not limited to the exemplary embodiments described above and may be modified, changed, and improved in various ways. For example, the modifications described above may be used in combination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that carries an image on an outer peripheral surface thereof;
a transfer member disposed such that an outer peripheral surface thereof is in contact with the outer peripheral surface of the image carrier, the transfer member transporting a recording medium, the transfer member transferring the image carried by the image carrier to the recording medium;
a leading end holding member disposed on the transfer member and holding a leading end of the recording medium in a transport direction;
a trailing end holding member disposed at a predetermined standby position such that a gap is formed between the trailing end holding member and the outer peripheral surface of the transfer member, the trailing end holding member being rotatable around the transfer member independently of the transfer member, the trailing end holding member holding a trailing end of the recording medium in the transport direction after the leading end of the recording medium in the transport direction held by the leading end holding member has passed through the gap while the transfer member rotates;
a detection unit that detects whether the leading end of the recording medium passes through the gap after the leading end holding member performed a holding operation on the leading end; and
a stopping unit that stops rotation of the transfer member when the detection unit detects that the leading end does not pass through the gap.

2. The image forming apparatus according to claim 1,
wherein the trailing end holding member is movable by a force applied to the trailing end holding member in the transport direction.

3. The image forming apparatus according to claim 2,
wherein the detection unit detects whether the leading end of the recording medium passes through the gap by detecting a position of the trailing end holding member.

4. The image forming apparatus according to claim 1, further comprising:
a contact member that is movable and disposed upstream of the standby position in the transport direction,
wherein the detection unit detects whether the leading end of the recording medium passes through the gap by detecting movement of the contact member.

5. The image forming apparatus according to claim 4,
wherein the contact member covers an upstream part of the trailing end holding member in the transport direction.

6. The image forming apparatus according to claim 1,
wherein the stopping unit stops rotation of the transfer member after rotating the transfer member in an opposite direction.

7. The image forming apparatus according to claim 1,
wherein the stopping unit stops rotation of the transfer member after the trailing end holding member rotates downstream in the transport direction of the recording medium.

8. An image forming apparatus comprising:
an image carrier that carries an image on an outer peripheral surface thereof;
a transfer member disposed such that an outer peripheral surface thereof is in contact with the outer peripheral surface of the image carrier, the transfer member transporting a recording medium, the transfer member transferring the image carried by the image carrier to the recording medium;
a leading end holding member disposed on the transfer member and holding a leading end of the recording medium in a transport direction;
a trailing end holding member disposed at a predetermined standby position, the trailing end holding member being rotatable around the transfer member independently of the transfer member, the trailing end holding member holding a trailing end of the recording medium in the transport direction after the leading end of the recording medium is held by the leading end holding member while the transfer member rotates;
a detection unit that detects a position of the trailing end holding member; and
a stopping unit that stops rotation of the transfer member when the detection unit detects that the trailing end holding member is not positioned at the standby position before the trailing end holding member holds the trailing end.

9. The image forming apparatus according to claim 8,
wherein the trailing end holding member is movable by a force applied to the trailing end holding member in the transport direction.

10. The image forming apparatus according to claim 8,
wherein the stopping unit stops rotation of the transfer member after rotating the transfer member in an opposite direction.

11. The image forming apparatus according to claim 8,
wherein the stopping unit stops rotation of the transfer member after the trailing end holding member rotates downstream in the transport direction of the recording medium.
